(19) United States
(12) Patent Application Publication
(10) Pub. No.: US 2019/0273343 A1
(43) Pub. Date: Sep. 5, 2019

(54) GROUNDING CONNECTION ELEMENT FOR SHIELDING ELECTRICAL COMPONENTS WHICH ARE ARRANGED IN PLASTIC HOUSINGS, AS WELL AS METHOD FOR ITS INSTALLATION

(71) Applicant: Balluff GmbH, Neuhausen a.d.F. (DE)

(72) Inventors: Henrik RUF, Neuhausen (DE); Kristof SIMON, Veszprem (HU)

(73) Assignee: Balluff GmbH, Neuhausen a.d.F. (DE)

(21) Appl. No.: 16/284,317

(22) Filed: Feb. 25, 2019

(30) Foreign Application Priority Data
Mar. 2, 2018 (DE) 10 2018 104 843.2

(51) Int. Cl. H01R 13/658

(52) U.S. Cl. CPC H01R 13/658

(57) ABSTRACT

A grounding connection element for electrical grounding and/or electromagnetic shielding of electrical components arranged in a plastic housing is provided with at least one electrical contact which is guided outwardly with respect to the plastic housing. The grounding connection element is formed by a substantially a spiral-shaped metal insertion part having a contact pin protruding out of a spiral-shaped region of the insertion part and the contact pin is fixedly arranged in an outwardly accessible, substantially cylindrical recess of the plastic housing.

### CROSS-REFERENCE TO RELATED APPLICATIONS

This application claims priority under 35 USC 119 of German Application No. 10 2018 104 843.2, filed on Mar. 2, 2018, the disclosure of which is herein incorporated by reference.

### BACKGROUND OF THE INVENTION

The invention relates to a grounding connection element for electrical/electromagnetic shielding or electrical grounding of electrical components which are arranged in a plastic housing and a method for installation of such a grounding connection element.

Such grounding connection elements are used in devices in electrical communication technology, for example in HF (“high frequency”) communication modules or LF (“low frequency”) evaluation units which have been distributed by the present applicant in the field of IO-link technology as well as RFID technology (“radio frequency identification”). In particular, said HF communication modules are already equipped with plastic housings. The grounding connection elements serve, for example, for electrically conductively connecting electrical components arranged within an electrical device, for example, circuit boards, to a grounding connection of the electrical device. Since it is well known that a lack of grounding negatively influences, for example, the electromagnetic compatibility of the electrical device.

In the simplest case, components arranged within the electrical device are electrically conductively connected to a grounding connection of the electrical device by means of an electrical connection. Here, the two ends of this electrical connection can be respectively soldered to the components and the grounding connection. There is a further possibility of using, for example, copper bands for screwing on both sides.

For shielding or grounding of so-called “industrial Ethernet” lines, the practice of providing these with screwable plug connectors arranged on a shielded signal line at its ends has additionally become known. Usually, the shielding of a cable plug connector is produced via a conductive nut having an external thread of the cable plug connector, said conductive nut being screwed into a conductive inner wall threaded sleeve of a round wall plug socket of the housing of the device. In this type of grounding, however, ground loops can be formed, for example, by interconnection of ground potentials, which ground loops can lead to disruptions in the transmitted signal and hence need to be interrupted. The interruption of ground loops and thereby the interruption of this connection of the shielding of the cable plug connector to the shielding of the device takes place by the internal threaded sleeve of the round wall plug socket to which the cable plug connector is connected, said internal threaded sleeve being formed in the walling, being produced from insulating material, in particular plastic. This requires the installation of corresponding round wall plug sockets in all devices and thus the refitting of all devices. Said disruptions gain an ever increasing significance with Ethernet transmissions of 100 Mbps and more and a star network of devices or device components required there.

A grounding connection element for an electrical device, in particular for housing electrical components, for example a drive device for a speed-controlled drive, is known from DE 203 03 240 U1, with which a circuit board which is spaced apart from a heat sink is electrically conductively connected to this grounded heat sink. This grounding connection element has at least two spring contact elements, wherein these two spring contact elements are configured such that they are in contact with a primary ground and at least one secondary grounding region. The grounding connection element is accommodated, in particular, in a plastic housing and is used, in particular, in electrical devices which have two or more circuit boards arranged one above the other in the housing interior. Here, a first circuit board is provided with a grounding connection which is electrically connected to a grounding connection portion of a second circuit board by means of the grounding connection element.

In DE 10 2008 020 503 A1, a grounding connection element is described in which a flexible band consisting of an electrically conductive material is provided which has two connection elements formed as a screw connection and as a soldered connection.

A housing arrangement having two circuit boards is known from DE 696 01 429 T3, in which several perpendicularly arranged bolts respectively have grounding recesses onto which the circuit boards are plugged. The low-location circuit board has several ground contacts, wherein the two circuit boards are conductively connected to one another by means of electrical contacts and are arranged spaced apart from one another. The bolts and the housing are formed integrally and also consist of an electrically conductive material. The two circuit boards are electrically conductively connected to the ground potential by means of plug contacts.

### SUMMARY OF THE INVENTION

The invention relates to devices preferably used in communication technology in the industrial environment, in which electrically shielded lines are provided for transmitting analogue or digital signals or communication signals, such as Ethernet signals. In known devices, the respective shielding is generally electrically or galvanically connected to a respective housing or housing part of a respective piece of electrical equipment by means of a mechanical thread, e.g. an M12 thread.

In the case of a metal housing, the shielding connected via such a thread is indeed automatically connected to a functional ground via the housing. However, this automatic grounding does not apply with plastic housings, which are increasingly being used.

Therefore, for shielding or grounding of two Ethernet ports arranged in a plastic housing, apparatus or grounding connection elements known to be technically relatively expensive are provided, for example rotation parts made of stainless steel which are expensive to produce, which are welded to metal bands by means of laser welding and are extrusion-coated or injected together in the housing during the production of the plastic housing.

Furthermore, in such a grounding system, with circuit boards arranged in a plastic housing, the grounding system must be galvanically connected both to the respective circuit board and also to the housing.

In addition there is increasingly the requirement, in particular in the HF communication modules or LF evaluation units referred to previously, of accommodating an Ethernet switch and/or additional analogue or digital functional modules in a plastic housing. Here, it is required that additional, for example 8, further Ethernet ports are connected to the grounding system.

Said known shielding devices are to be produced in a relatively expensive manner and are thus also relatively costly.

The invention proposes a grounding connection element which is technically relatively simple to achieve and thus also relatively low-cost, in which a substantially spiral-shaped metal insertion part is provided.

The spiral-shaped or helical-shaped insertion part is preferably introduced into a region of the respective device or the plastic housing during a usual injection-moulding process for producing an internal thread which is outwardly accessible on the plastic housing, said region being provided for the internal thread, by means of a spindle-like or mandrel-like tool, e.g. an insertion mandrel or assembly mandrel. For this purpose, the insertion mandrel has an external thread, onto which the spiral-shaped insertion part is positively and/or frictionally screwed before the installation in the device housing, or is wound on a spindle similarly to in the production of a wire coil.

After the introduction of the insertion mandrel having the insertion part, the mandrel and the insertion part are extrusion-coated or rear-injected by the plastic during the injection-moulding process and are thus enclosed in the plastic. As a result, the spiral-shaped insertion part is thus incorporated into the plastic housing in the region, and thus automatically represents a part of the injection-moulded internal thread. After the cooling of the injected plastic, the insertion mandrel can be rotated out or wound out again.

This function of the insertion part as a part of the internal thread can be further improved by the metal spiral or the underlying metal wire tapering in a wedge-like or acute manner on the inner side of the spiral in order to provide a thread flank for the injection-moulded internal thread, which is required or advantageous for the injected internal thread.

Instead of only one insertion mandrel, the tool can have a multiplicity or a plurality of, for example, eight (8) such insertion mandrels, by means of which a corresponding plurality of internal threads can simultaneously be produced on the device, or subsequently on its plastic housing which is optionally already present, in only one injection-moulding process.

A galvanic connection to further electrical components arranged in the plastic housing, e.g. to IO ports, Ethernet ports, Ethernet switches or similar, can in turn be created simply and cost-effectively, by means of a soldering contact or contact pin or soldering pin arranged on the insertion part, preferably on an end of the metal spiral. Furthermore, the soldering contact has the further advantage that the spiral-shaped insertion part cannot be accidentally unscrewed again during unscrewing of the tool or the thread after the injection moulding process which has taken place, due to the cylinder symmetry of the spiral having been disrupted by the soldering pin.

If, in the later operation of the device, an internal thread produced in this way is screwed into a plug provided with a metal external thread and corresponding grounding, e.g. a connection plug of an Ethernet port, then a secure grounding or shielding of the Ethernet port automatically takes place after the screwing of this plug by means of the connection to the device ground.

In the proposed grounding connection element for electrically grounding and/or electromagnetically shielding electrical components arranged in a plastic housing, wherein the grounding connection element provides at least one electrical contact which is guided outwardly with respect to the plastic housing, it is provided, in particular, that the grounding connection element is formed by a substantially spiral-shaped metal insertion part having a contact pin protruding out of a spiral-shaped region of the insertion part, said contact pin being fixedly arranged in an outwardly accessible, substantially cylindrical recess of the plastic housing. The insertion part is fixed or held on the inner side of the recess or held there, preferably by means of plastic which has been injected into the recess.

Here, the contact pin which is preferably formed as a soldering pin can protrude out of the spiral-shaped region of the insertion part substantially along a spiral axis of the spiral-shaped region of the insertion part, or out protrude of the spiral-shaped region of the insertion part in the region of spiral arms of the insertion part.

The insertion part can be formed of a metal material, in particular of a softly solderable material. The insertion part can furthermore be coated with surface materials common in electrical connection technology, e.g. gold or silver.

In the proposed method for installing a grounding connection element formed as a substantially spiral-shaped metal insertion part in a plastic housing by means of injection moulding, it is provided, in particular, that the insertion part is applied to or screwed onto an insertion mandrel, by means of which the insertion part is securely held in a recess of the plastic housing during an injection moulding process.

In the proposed method, it can furthermore be provided that the contact pin or corresponding soldering pin of the insertion part protrudes towards the inner side of the plastic housing after the installation of the insertion part in the plastic housing and is connected galvanically or by means of soldering technology to at least one electrical component arranged in the plastic housing.

According to an aspect of the invention, it is provided that the insertion part is extrusion-coated with plastic in the region of the recess, wherein at least a part of the soldering pin is held in an unsplashed state.

A grounding connection element according to the invention can be produced which is significantly simpler and thus also more cost-effective compared to the prior art, whereby the production of an electrical device having a plastic housing having a corresponding grounding system is also significantly more cost-effective.

The plastic thread which is finally arranged in the plastic housing is additionally mechanically fastened or stabilised by the metal insertion part and thus enables a longer service life in the operation of the relevant device.

The insertion part can be relatively simply galvanically connected, for example, to a circuit board arranged in the plastic housing, by means of the soldering contact arranged on an end of the spiral-shaped insertion part, without an additional laser welding connection being required here.

As a result, relevant electrical devices can be produced having a plastic housing and having grounding which is required on IO ports and/or Ethernet ports, which can be produced in a significantly simpler and more cost-effective manner compared to the prior art.

### BRIEF DESCRIPTION OF THE DRAWINGS

FIGS. 1a, b show various isometric views of a first grounding connection element according to the prior art;

FIGS. 2a-c show various isometric views of a second grounding connection element according to the prior art arranged in a plastic housing of a communication technology device;

FIGS. 3a-d show various isometric views of a grounding element arranged in a plastic housing of a communication technology device, according to an exemplary embodiment of the invention; and

FIGS. 4a-c show method steps depicted in an isometric view for installing the proposed grounding connection element in a plastic housing of a communication technology device.

### DETAILED DESCRIPTION OF THE EMBODIMENTS

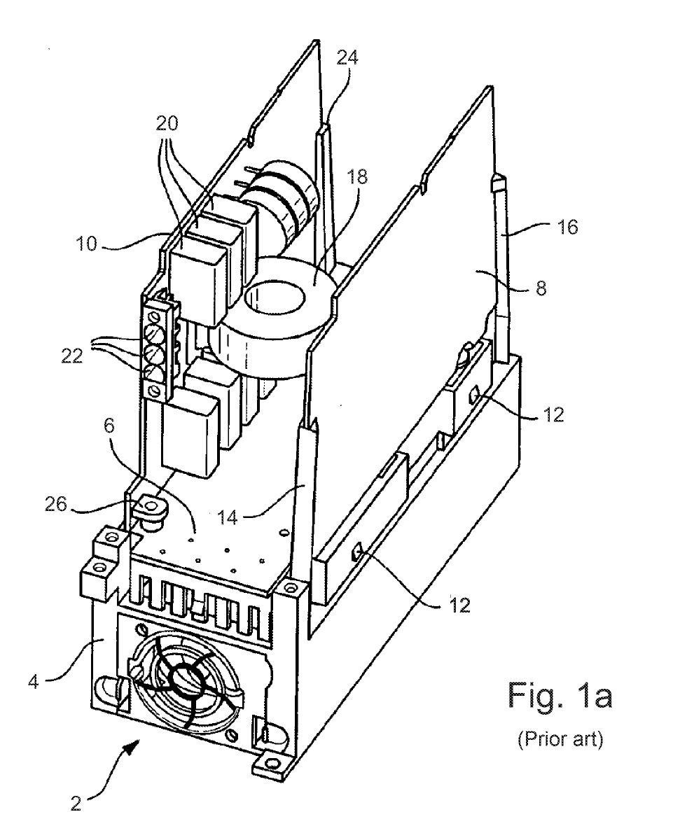

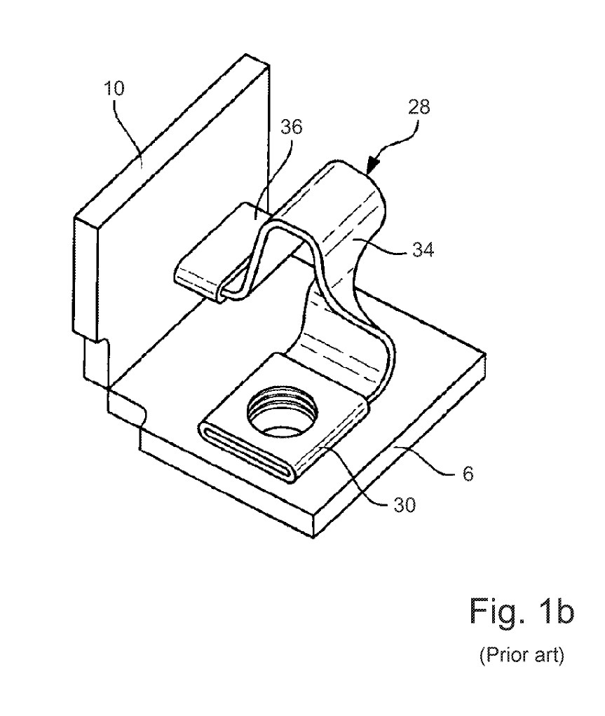

In FIG. 1a, an isometric view of an electrical device 2 (here a power converter) with a detached housing is depicted. The device 2 has a cooling element 4, a first circuit board 6, a second circuit board 8 and a third circuit board 10. Power semiconductor modules 12 are arranged on the cooling element 4 and thermally conductively connected to the cooling element 4. The first circuit board 6 is electrically conductively connected to the connections of these power semiconductor modules 12. This first circuit board 6 has, for example, control units for the power semiconductor modules 12. The second circuit board is arranged perpendicular to the first circuit board 6 in the device 2. Two guide rails 14 and 16 are provided for holding the second circuit board 8.

The second circuit board 8 has structural elements and electrical wiring of a control- and regulation means of the device 2. The third circuit board 10, which has, for example, a filter 18, several intermediate circuit capacitors 20 and circuit board connections 22, is arranged perpendicular to the first circuit board 6 in the interior of the device 2, just as the second circuit board 8. The third circuit board 10 is arranged on one side in a guide rail 24. Opposite the guide rail 24, the third circuit board 10 is connected to the first circuit board 6 by means of an integral, plug-in high-current contact 26. Such a high-current contact 26 is formed to be rectangular, wherein a first leg of the high-current contact element 26 has several soldering pins and a second leg of the high-current contact 26 has a bore.

The high-current contact 26 can be soldered in the same soldering process as the third circuit board 10, in which the structural elements 18, 20 and 22 of the third circuit board 10 are also soldered. The connection to the first circuit board 6 takes place by means of a screw which is screwed to the cooling element 4 through the first circuit board 6. So that the third and the first circuit boards 10 and 6 are electrically conductively connected to the cooling element 4, which represents a ground connection, the high-current contact 26 is formed of electrically conductive material.

According to FIG. 1b, the grounding connection element 28 is formed by a flexible band 34 having a second connection element 36, wherein the first connection element 30 is formed as a screw connection and the second connection element 36 is formed as a soldered connection. The flexible band 34 consists of an electrically conductive material. So that the band 34 is flexible, it is interwoven here, corresponding to a copper band having screwing on both sides. The two connection elements 30 and 36 are electrically conductively connected to one another by means of the flexible band 34.

The second connection element 36 of the grounding connection element 28, said second connection element being formed as a soldered connection, has four soldering pins (not shown) which protrude out of the third circuit board 10 on the soldering side.

As can further be seen from FIG. 1b, the fastening axes of the two connection elements 30 and 36 in the integral grounding connection element 28 are indeed orthogonal with respect to one another, but do not however, intersect. For each connection element 30 and 36 of the grounding connection element 28, a fastening point is provided respectively on a circuit board 6 or 10, which does not obstruct the screwing of the screw connection 30 of the grounding connection element 28. The connection radius for the two connection elements 30 and 36 is additionally restricted by the length of the flexible band 34 of the grounding connection element 28.

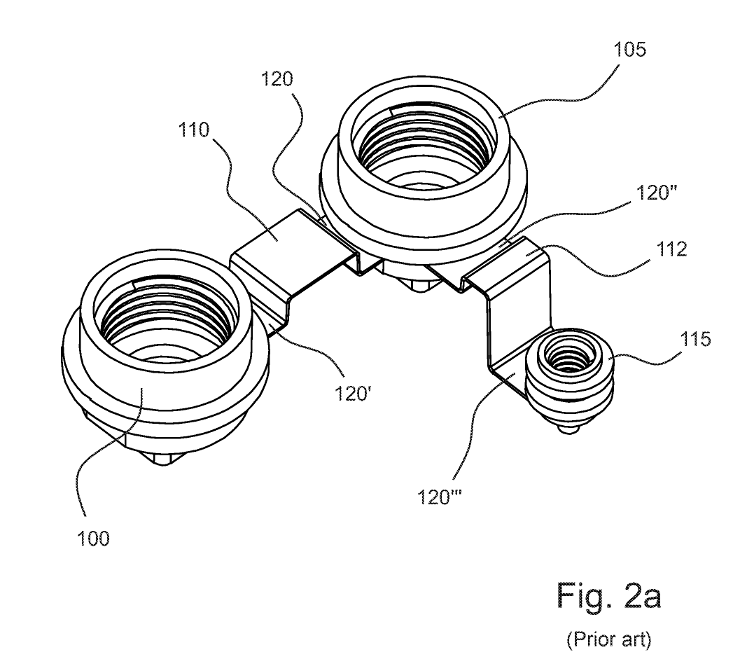

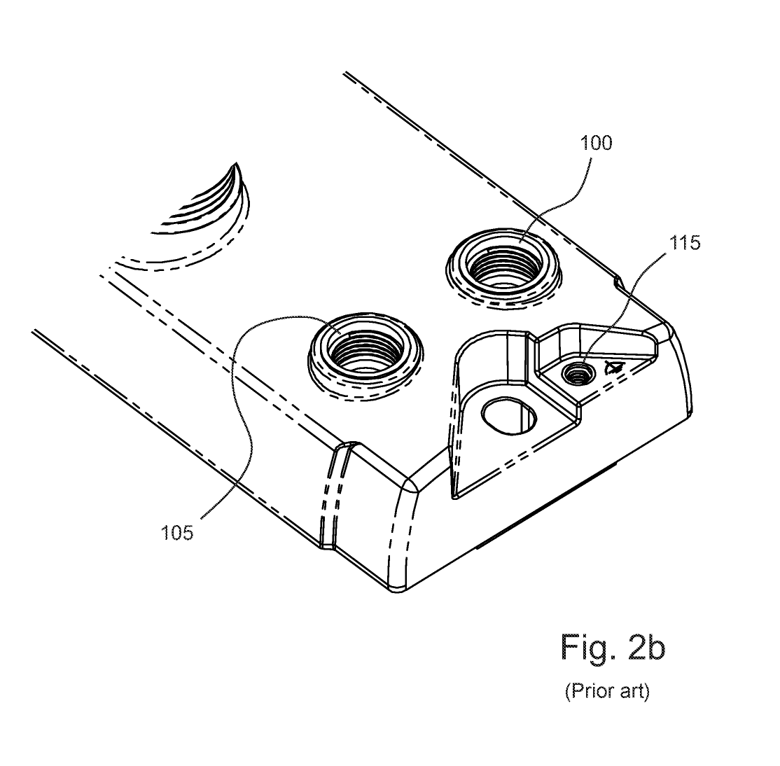

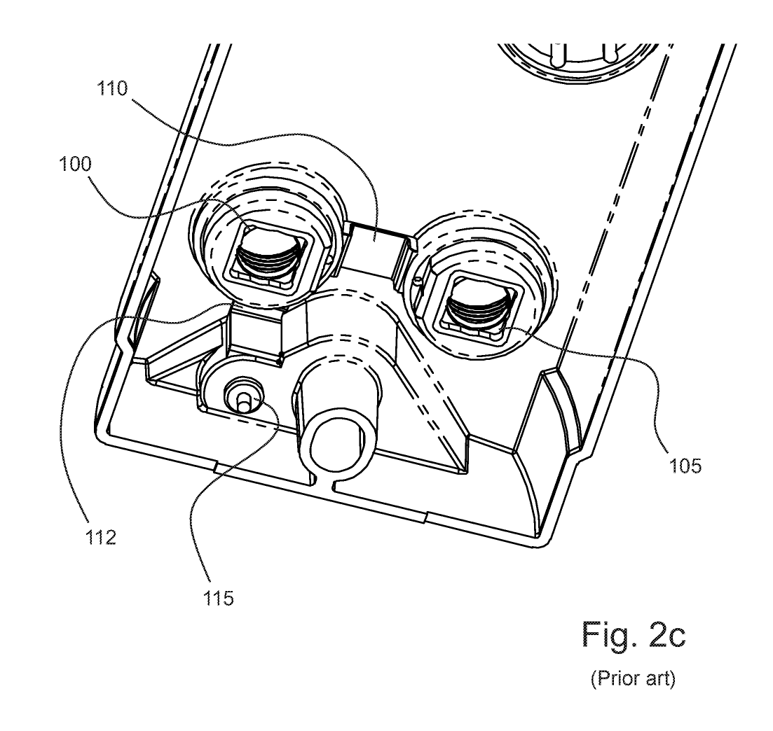

FIGS. 2a-2c show a grounding connection element according to the prior art which is suitable as an insertion part for the injection moulding, before and after installation in a plastic housing.

As can be seen in FIG. 2a, in these insertion parts, metal connection elements or bridge elements 110, 112 are arranged between three screw contacts 100, 105, 115 in the present example in order to galvanically couple the screw contacts 100, 105, 115 to one another. Here, the screw contacts 100, 105, 115 are connected to the respective connection elements or bridge elements 110, 112 via welds 120, 120′, 120″, 120″, which frequently break or tear during installation of the insertion part by injection moulding, due to the higher temperatures which arise here, whereby, in particular, the galvanic coupling between the screw contacts 100, 105, 115 no longer exists or is not guaranteed.

In FIG. 2b, an isometric plan view of a plastic housing is shown, the insertion part shown in FIG. 2a already having been installed in said plastic housing by means of injection moulding. In this depiction, in particular, the screw contacts 100, 105, 115 which are arranged to be substantially aligned with the housing surface can be seen. In FIG. 2c, the corresponding rear view of the plastic housing shown in FIG. 2b is depicted, wherein, in this view, not only the three screw contacts 100, 105, 115 can be seen from the underside of the housing, but also the two bridge elements 100 and 112.

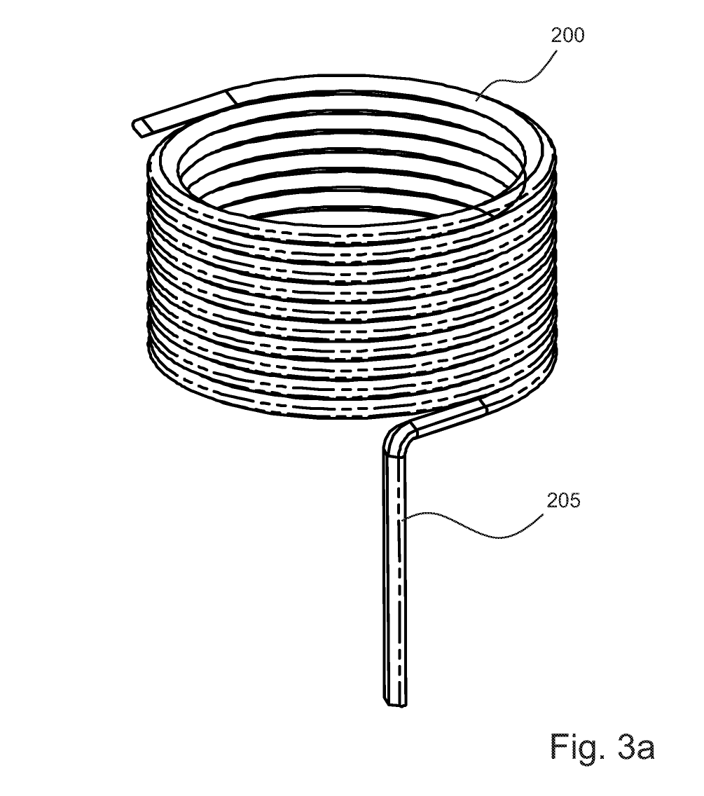

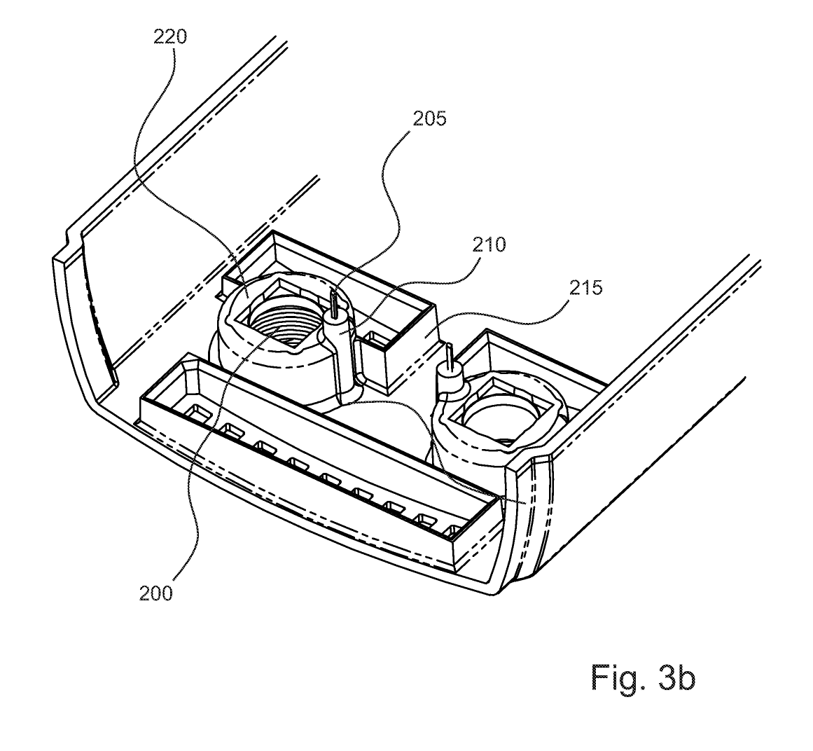

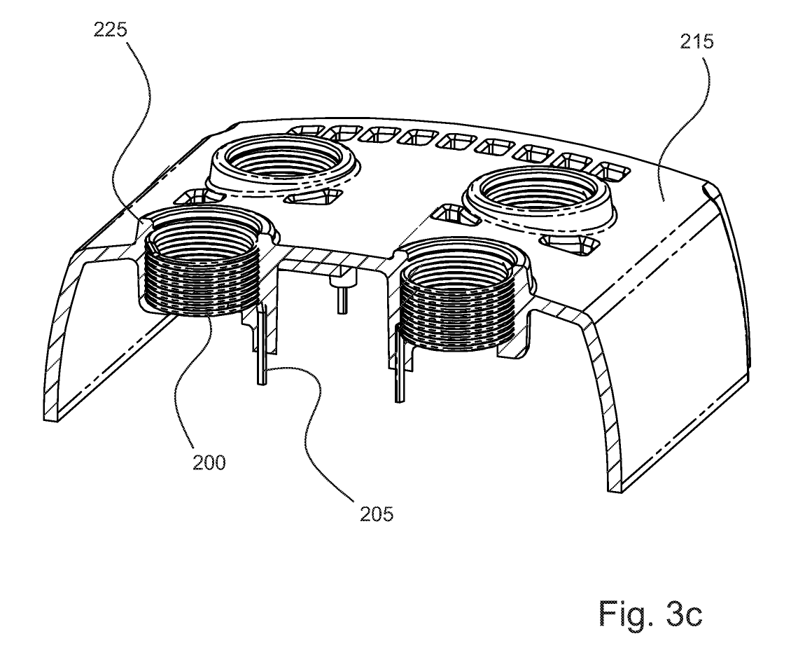

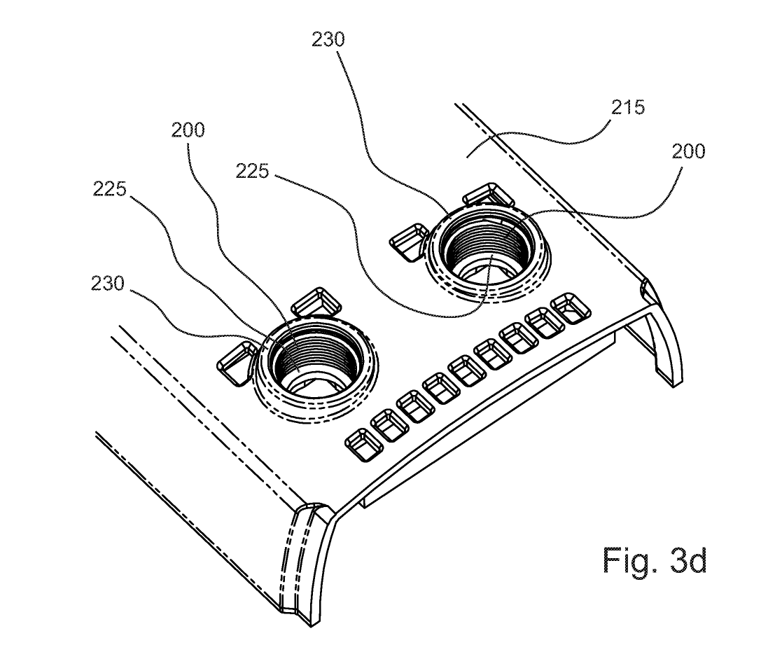

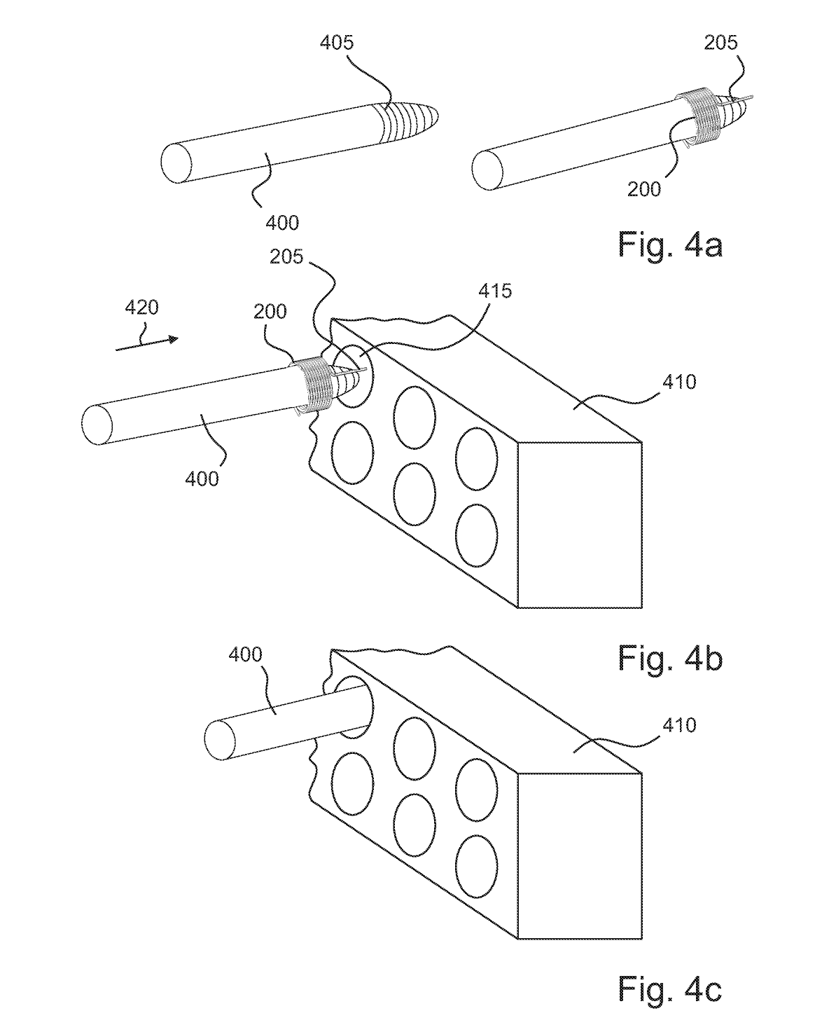

FIG. 3a shows a spiral-shaped metal insertion part 200 having a soldering pin 205 protruding out of the spiral arm plane approximately along the spiral axis in the edge region of the spiral arm. The insertion part 200 is, as described in yet more detail subsequently using FIGS. 4a-4c, either installed in a corresponding recess of an existing plastic housing or is already installed in it during the production of such a plastic housing. Electrical structural parts or circuit boards which are approximately arranged in the housing can then be galvanically connected to the ground potential provided by the insertion part 200 by means of the soldering pin 205.

For installing the insertion part 200, 205 in the plastic housing 215, the insertion part 200 having the side facing away from the soldering pin 205 is unscrewed or screwed onto a mandrel which serves as an insertion mandrel and is shown in FIGS. 4a-c, by means of the spiral windings which form an internal thread. For this purpose, the thread has a corresponding external thread for receiving the spiral-shaped insertion part 200. Subsequently, plastic is injected in the installation region of the insertion part, wherein, in the injection process, at least a part of the soldering pin 205 remains in the unsplashed or blank state in order to be able to use it subsequently for galvanic connection to and corresponding grounding or shielding of electrical components arranged in the housing.

In FIG. 3b, the installation situation which exists after the installation of the insertion part 200, 205 in the plastic housing 215 is illustrated, seen from the underside of the housing or the side having the soldering contacts (soldering side) of the housing or a corresponding inner region of the housing. Here, the soldering pin 205 which has not been soldered points upwards in this depiction and protrudes out of the extrusion-coated plastic 210 around the region shown, so that a said soldering connection can be produced having an electrical component (not shown) arranged in the plastic housing, for example an Ethernet port, an Ethernet switch and/or a further analogue or digital functional module. Here, the respective electrical component can be connected to the soldering pin 205, e.g. by means of the soft soldering which is usual in electronics, using soldering technology.

In FIG. 3c, the existing installation situation is depicted seen from the outer side of the housing. Here, the housing is partially cut open in the region of the installed insertion part 200, 205 for illustration purposes, whereby the housing part 225 in which the screw contact having the insertion part 200 is formed by the insertion part 200 can be seen. Here, it is emphasised that the original metal spiral of the insertion part 200 tapers on its inner side in a wedge-shaped or acute manner in order to provide the thread flank which is necessary as an internal thread of the screw contact. When screwing a plug having a metal external thread into the screw contact, wherein the external thread of the plug is grounded, a galvanic connection of the plug to the grounding system of the plastic housing is automatically produced by the screwing process.

FIG. 3d shows the installation situation shown in FIG. 3c without the cut-out used there, i.e. in an isometric view of the housing surface. In this view, it can be seen, in particular, how the screw contact is aligned with the housing surface and, in this exemplary embodiment, an edge bead 230 is formed on the edge of the screw contact opening, by means of which the screw contact is mechanically reinforced or stabilised.

In FIGS. 4a-4c, the method steps for installing a grounding connection element or corresponding insertion part, relevant here or previously described, in a plastic housing are illustrated.

In FIG. 4a, an insertion part 400 having an external thread 405 arranged on the mandrel tip is shown on the left. In FIG. 4a, the insertion mandrel 400 having an insertion part 200 (see FIG. 3a) which is coiled on the mandrel tip 200 and spiral-shaped is depicted on the right, wherein the soldering pin 205 is arranged in the direction of the mandrel tip. FIG. 4b shows how the mandrel 400 having the insertion part 200 which has already been coiled is guided according to the direction arrow 420 to a cylindrical recess 415 of the plastic housing 410 in a forthcoming injection moulding process. Before the beginning of the injection moulding process, in which liquid plastic is injected, in particular in the region of the recess 415, the insertion mandrel 400 according to FIG. 4c is introduced into the recess 415 to the point that the insertion part 200 is fully located within the recess 415.

It should be noted that a respective insertion part can be installed in only one working step or injection process by means of a parallel arrangement of several insertion mandrels in several recesses, for example, five recesses in addition to the other ones in the depiction.

What is claimed is:

1. A grounding connection element for electrically grounding and/or electromagnetically shielding electrical components arranged in a plastic housing, wherein the grounding connection element provides at least one electrical contact which is guided outwardly with respect to the plastic housing, wherein the grounding connection element comprises a substantially spiral-shaped metal insertion part having a contact pin protruding out of a spiral-shaped region of the insertion par, said contact pin being fixedly arranged in an outwardly accessible, substantially cylindrical recess of the plastic housing.

2. The grounding connection element according to claim 1, wherein the contact pin is formed as a soldering pin and protrudes out of the spiral-shaped region of the insertion part substantially along a spiral axis of spiral-shaped region of the insertion part.

3. The grounding connection element according to claim 2, wherein the soldering pin protrudes out of the spiral-shaped region of the insertion part in a region of spiral arms of the insertion part.

4. The grounding connection element according to claim 1, wherein the spiral-shaped region of the insertion part is wedge-shaped in order to provide a thread flank.

5. The grounding connection element according to claim 1, wherein the insertion part is formed of a metal material.

6. The grounding connection element according to claim 5, wherein the insertion part is formed of a softly solderable material.

7. The grounding connection element according to claim 5, wherein the insertion part is coated with surface materials common in electrical connection technology.

8. The grounding connection element according to claim 1, wherein the insertion part is fixed on the inner side of the cylindrical recess by means of plastic which is injected into the recess.

9. A method for installing a grounding connection element which is formed as a substantially spiral-shaped metal insertion part according to claim 1, in a plastic housing by injection moulding, comprising applying the insertion part to an insertion mandrel, and holding the insertion part in a recess of the plastic housing with the mandrel during an injection moulding process.

10. The method according to claim 9, wherein at least two insertion mandrels are provided, by means of which a plurality of at least two internal threads are produced in only one injection moulding process.

11. The method according to claim 9, wherein the contact pin of the insertion part protrudes towards an inner side of the plastic housing after installation of the insertion part in the plastic housing, and is connected to at least one electrical component arranged in the plastic housing, said component being connected galvanically or by means of soldering technology.

12. The method according to claim 9, wherein the insertion part is extrusion-coated with plastic in a region of the recess of the plastic housing, wherein at least a part of the contact pin is held in an unsplashed state.
